(19) United States
(12) Patent Application Publication
(10) Pub. No.: US 2019/0370835 A1
(43) Pub. Date: Dec. 5, 2019

(54) Systems And Methods For Recommendation System Based On Implicit Feedback

(71) Applicant: Systems and Software Enterprises, LLC, Brea, CA (US)

(72) Inventors: Nicolas Aussel, München (DE); Eriza Fazli, Gilching (DE); Matteo Berioli, Munich (DE)

(21) Appl. No.: 16/428,632

(22) Filed: May 31, 2019

Related U.S. Application Data
(60) Provisional application No. 62/679,566, filed on Jun. 1, 2018.

(51) Int. Cl. G06Q 30/02; H04L 29/08; G06Q 30/06

(52) U.S. Cl. CPC G06Q 30/0205; H04L 67/22; G06Q 30/0631; H04L 67/12

(57) ABSTRACT

Systems and methods are described for providing a recommendation system for a vehicular content distribution network. A static recommendation list can be generated based on travel characteristics stored in a server. An efficiency threshold can be calculated or provided that sets the point at which the static recommendation should no longer be used for recommendations and the recommendation system can be used. Data is gathered of each user's preference based on implicit feedback, and the data is then analyzed to calculate an efficiency level of the recommendation system operating with gathered data for a user. The recommendation system is automatically used for a specific user when the efficiency level meets or exceeds the efficiency threshold.

This application claims priority to U.S. provisional application having Ser. No. 62/679,566 filed on Jun. 1, 2018. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is recommendation systems and methods.

### BACKGROUND

The following description includes information that may be useful in understanding the present invention. It is not an admission that any of the information provided herein is prior art or relevant to the presently claimed invention, or that any publication specifically or implicitly referenced is prior art.

Online stores and user-generated media platforms utilize recommendation systems to facilitate browsing of a high number of items. Such systems generally rely on centrally-stored data about a user's preferences and either intrinsic properties of the items (i.e., content-based recommenders) or other users' preferences (i.e., collaborative filtering recommenders).

In some circumstances, it is best to combine the above two systems so that the best suited approach can be dynamically selected depending on the situation (i.e., a hybrid recommender).

The efficiency of a recommendation system is generally limited by the data the system can access concerning a user's preferences. When not enough data is available, the recommendation system often cannot operate efficiently. Such situation is often referred to as the cold start problem.

To gather the necessary data, there are two common approaches. The first approach requires new users to fill out a survey requesting direct feedback on several items in the form of ratings. The second approach is to disable the recommendation system until the user has provided a minimum amount of feedback.

However, because the number of requests per user can often be low or below the minimum amount of feedback, especially, it is possible that the system could always remain in a cold start situation. This is especially true where the system is deployed in an aircraft or other vehicle such as shown in FIG. 1.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for systems and methods for recommendation systems that overcome the cold start situation for in-vehicle systems.

### SUMMARY OF THE INVENTION

The inventive subject matter provides apparatus, systems and methods for providing a recommendation system for a vehicular content distribution network. A server can be provided having a processor and memory, wherein the server is communicatively coupled to an in-vehicle network for distributing content to a plurality of users. The server could be connected with a plurality of in-flight entertainment devices, such as those typically disposed within a seat back of a vehicle, but may also be connected with one or more devices of the users. Such user devices could include, for example, smart phones, tablet PCs, laptop computers, and other portable computing devices.

A static recommendation list can be generated based on travel characteristics stored in the memory.

An efficiency threshold can be calculated or provided, which sets the point at which the static recommendation should no longer be used for recommendations and the recommendation system should instead be used. The efficiency threshold can be based at least in part on flight characteristics stored in the memory, which could include, for example, (i) a length of the flight, (ii) an amount of content available on the flight, (iii) a type and/or diversity of content available on the flight, and (iv) feedback from passengers on prior flights.

As data is gathered about each user's preferences based on implicit feedback, the data can be analyzing to calculate an efficiency level of the recommendation system operating for a user. If the efficiency level meets or exceeds the efficiency threshold, the system can automatically switch from using the static recommendation list to using the recommendation system for that user.

Contemplated implicit feedback can comprise interaction of the user with an in-flight entertainment system, which can include, for example, (i) the user selecting a piece of content, (ii) the user reviewing details of a piece of content, (iii) the user liking a piece of content, (iv) the user adding a piece of content to a playlist, and (v) the user skipping a piece of content.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is an exemplary chart showing a number of moves watched per passenger on flights.

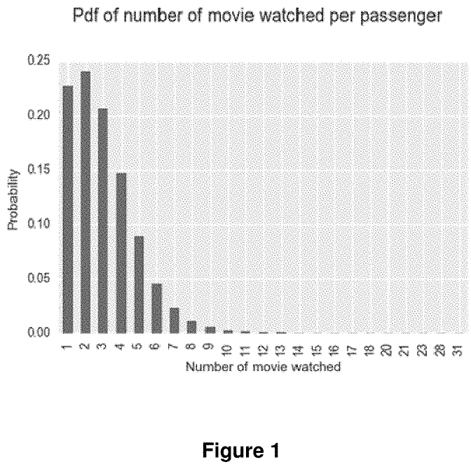

FIG. 2 is a flowchart of one embodiment of a method for providing a recommendation system for a vehicular content distribution network.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Although the discussion herein focuses on an aircraft, it is contemplated that the systems and methods discussed herein could likewise be used on ships, trains, busses, and other vehicles.

The inventive subject matter describes systems and methods for providing a recommendation system that overcomes the cold start situation, especially in circumstances where the number of user requests may be persistently low. Using such systems and methods, a recommendation system can be provided for an in-vehicle network where users will engage with the system for a finite period, often a few hours.

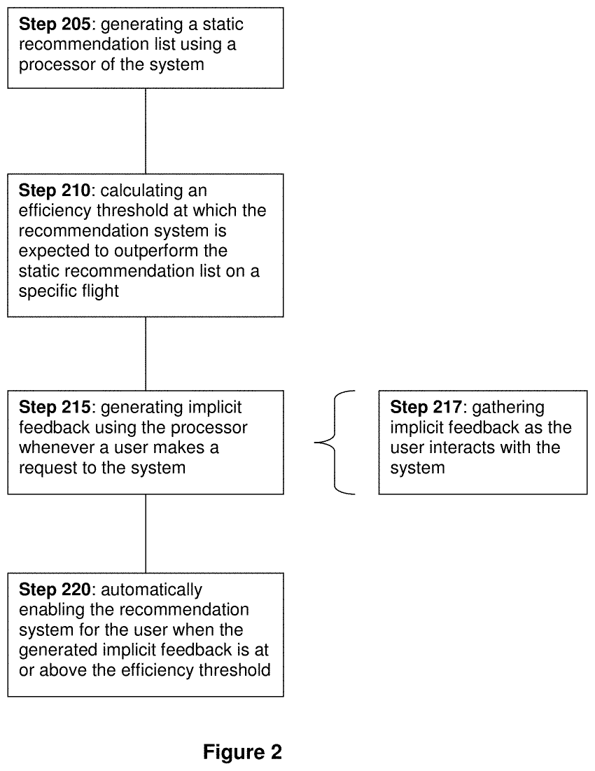

Contemplated systems and methods comprise a series of steps. FIG. 2 illustrates one embodiment of a method 200 for providing a recommendation system for a vehicular content distribution network. In step 205, a static recommendation list can be generated using a processor of the system or be imported from an external system. The recommendation list is preferably based on a set of travel characteristics, which may include, for example, users' demographics, if available. This recommendation list can be used during the cold start phase in place of the recommendation system. This may include, for example, an early part of the flight where the user has yet to interact with the system.

In step 210, the system receives or calculates an efficiency threshold at which the recommendation system is expected to outperform the static recommendation list on a specific flight, for example. Such threshold can be computed dynamically during flight or can be generated offline. It is contemplated that such threshold can be specific for each flight and may vary between flights depending on various characteristics of the flight including, for example, a length of the flight, an amount of content available on the flight, a type and/or diversity of content available on the flight, and feedback from passengers on prior flights.

In step 215, the system can generate implicit feedback using the processor whenever a user makes a request to the system. When the generated implicit feedback is at or above the efficiency threshold for that flight, the recommendation system is automatically enabled for that user in step 220. Thus, on a specific flight, passengers or users can be grouped into two groups: (i) those using the static recommendation list, and (ii) those using the recommendation system. During the flight, it is contemplated that some or all of the passengers or users will transition from the static recommendation list to the recommendation system as the implicit feedback for a user meets or exceeds the efficiency threshold for the flight.

The system can also be configured to offer various manners for soliciting implicit feedback from a user including asking the user to state whether the user likes or dislikes a piece of content or a genre/category of content. Implicit feedback can also be gathered in step 217 as the user interacts with the system. Such feedback could include, for example, what pieces of content are accessed or viewed by the user, and whether the user requests additional information about a piece of content (e.g., the user may read a more detailed description of a movie or watch a trailer, but not end up watching the movie). However, this could show interest in a genre, actor, or certain other type of movie as compared with movies that were not reviewed in detail, and provide feedback in that regard.

Other contemplated feedback could include, for example, content skipped or not selected by the user, especially after details about the content are reviewed, as well as any playlists of content are created by the user.

It is contemplated that such system can also import existing ratings, user profiles, and so forth of a user if permitted. This could include rankings of movies, television, etc. from other services that may be provided via an application stored on a smart phone, tablet PC, or other portable computing device. In such circumstances, it is contemplated that the existing information could be synced with the system.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for providing a recommendation system for a vehicular content distribution network, comprising:
providing a server having a processor and memory, wherein the server is communicatively coupled to an in-vehicle network for distributing content to a plurality of users;
computing a static recommendation list using the processor based on travel characteristics stored in the memory;
computing an efficiency threshold at which the static recommendation should no longer be used for recommendations using the processor;
gathering data on each user's preferences based on implicit feedback and storing the data in the memory; and
analyzing the gathered data using the processor to calculate an efficiency level of the recommendation system operating with gathered data using a processor for a user, and automatically switching from the static recommendation list to a recommendation system for that user when the efficiency level meets or exceeds the efficiency threshold.

2. The method of claim 1, wherein the implicit feedback comprises interaction of the user with an in-flight entertainment system.

3. The method of claim 2, wherein the interaction comprises one or more of (i) the user selecting a piece of content, (ii) the user reviewing details of a piece of content, (iii) the user liking a piece of content, (iv) the user adding a piece of content to a playlist, and (v) the user skipping a piece of content.

4. The method of claim 1, wherein the efficiency threshold is based at least in part on flight characteristics stored in the memory.

5. The method of claim 4, wherein the flight characteristics comprises at least one of (i) a length of the flight, (ii) an amount of content available on the flight, (iii) a type and/or diversity of content available on the flight, and (iv) feedback from passengers on prior flights.

6. The method of claim 4, wherein the efficiency threshold varies for different flights.

7. The method of claim 1, wherein the travel characteristics comprise user demographics.
